(19) United States
(12) Patent Application Publication
(10) Pub. No.: US 2015/0187032 A1
(43) Pub. Date: Jul. 2, 2015

(54) System and Method for Tracking Payment Agreements

(71) Applicants: Khalid Mirza, Rowlett, TX (US); Huntly G. Chapman, Dallas, TX (US)

(72) Inventors: Khalid Mirza, Rowlett, TX (US); Huntly G. Chapman, Dallas, TX (US)

(21) Appl. No.: 14/145,749

(22) Filed: Dec. 31, 2013

(51) Int. Cl. G06Q 50/18; G06Q 50/22; G06Q 30/04

(52) U.S. Cl. CPC G06Q 50/18; G06Q 30/04; G06Q 50/22

(57) ABSTRACT

A system and method for associating a patient with professional services, such as attorney and physician, that are required due to injury or other calamities, such as auto accidents or home fire. The patient data is compared to criteria entered by the professional service providers. Upon agreement between the parties, an LOP is generated. The patient's claim is tracked until it is finalized. The service provider is then notified that the case is ended and contingency fees, if any, are due. In an alternative embodiment, an insurance company is a party. The insurance company may use the system to verify that services are rendered and appointments kept.

### PRIORITY

This application is a continuation of U.S. application Ser. No. 13/936,141; filed on Jul. 6, 2013.

### FIELD

The present invention relates to the automatic validation, tracking, and reporting of cases and generation of payment requests for agreements between two parties by tracking information from one or more third parties relating the cases.

### BACKGROUND

LOPs (Letters of Protection) exist between parties in order to defray a client's bills until a settlement is reached in a case. In general, an attorney creates an LOP agreement with one or more medical professionals. In an LOP, the attorney promises to reimburse the medical professional for a client's medical bills once the client's claim or legal case has ended.

The medical professional mitigates their risk of exposure to non-payment, by having a security note (LOP) for the medical services rendered to the patient. The attorney benefits by not being out of pocket for a client's medical bills until a settlement is made on the client's behalf. The client benefits by receiving much needed medical attention and examinations while their case is ongoing. Also, the case itself may benefit, either through the medical professional's testimony, test results, or exhibits necessary for the case.

Issues arise when a pending case becomes completed and it is time for the attorney to pay the outstanding LOP. Generally, the LOP is payable on demand by the medical professional. Any settlement is paid to the attorney's trust account on behalf of the client, where it resides until the medical professional's demand. Unfortunately, the attorney has no incentive to notify the medical professional of the conclusion of the case and render payment of the LOP. As the length of cases varies and may last a year or more, the medical professional is uncertain as to when the LOP is due. This uncertainty results in delays in payment to the medical professional, often delaying payments for six months or more after the conclusion of a client's case. Additionally, the uncertain due date of the LOP requires repeated inquiry by the physician or their staff, often by calling the attorney or insurance company and requesting an update on the status of the client's case or claim. This results in wasted time and effort by the physician, the attorney, and the insurance company, or their respective staff. In some cases, due to the frustration involved and the length of time required to resolve a case, the LOP is written off by the medical professional or sold to collection services resulting in a net loss.

Thus, there exists a need to track changes to a client's case and notify the respective parties of ongoing developments or settlements. Additionally, there is a need to automate this process to the greatest extent possible. Finally, there exists a need to create an automatic billing process based on the conclusion of the case. The result being a savings in time and expedited payment to the medical professional or medical facilities.

### BRIEF DESCRIPTION OF THE DRAWINGS

FIGS. 1 and 2 show a block diagram depicting the interaction of the various customers through the service in accordance with an embodiment of the present invention.

FIG. 3 shows a block diagram depicting the creation of an LOP in accordance with an embodiment of the present invention.

FIG. 4 shows a block diagram depicting the listing process of an LOP in accordance with an embodiment of the present invention.

FIG. 5 shows a block diagram depicting in detail the various stages of an LOP, including modifications that might be made, in accordance with an embodiment of the present invention.

FIG. 6 shows a diagram depicting the various services offered by the service and the interaction between potential customers in accordance with an embodiment of the present invention.

### DETAILED DESCRIPTION OF PREFERRED EMBODIMENTS

Initially upon joining the subscription service, new subscribers are required to fill in basic contact information along with the nature of the services that they are able to provide. For example, a doctor that is seeking additional patients may indicate the nature of his specialty, as well as other services he is willing to provide. Additionally, the doctor may note that they are willing to accept a LOP. A patient or his legal representative may join the subscription service needing care for the patient, but wishing to delay payment until legal case has settled. Thus, the doctor benefits by having additional patients, with a promise to pay secured by the LOP, and the patients benefit by having medical care provided prior to the conclusion of a lawsuit or pending insurance settlement. Subscribers may include anyone that participates in the subscription service, including attorneys, medical professionals, insurance companies, advertisers and patients (clients, injured parties).

Subscribers may come to the service for a variety of reasons. A legal representative or patient generally joins the service in search of a physician or other medical professional that is willing to provide services in advance and receive payment once a case has been finalized. The service provides an attorney or legal representative of the patient with a selection of medical professionals—based on a variety of criteria including specialty and location—that are willing to provide needed services in advance of a settlement.

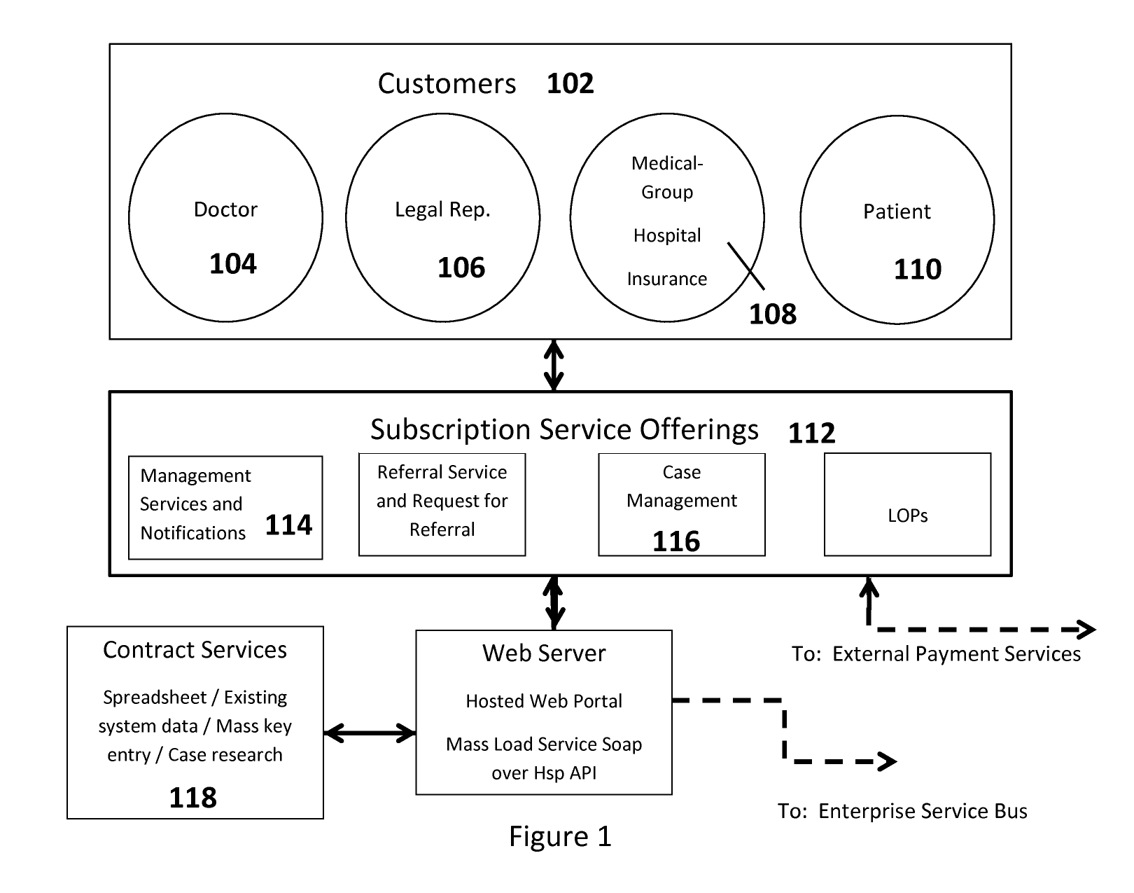

As shown in FIG. 1 customers 102 of this subscription service 112 may be a medical professional 104, legal representative 106, insurance company 108, hospital, or a patient/client 110. Initially, the customers 102 are brought together through a subscription service 112. The subscription service 112 provides a user controlled matching service between customers 102 that share an interest in either a specific case or in providing services to one of the other customers 102.

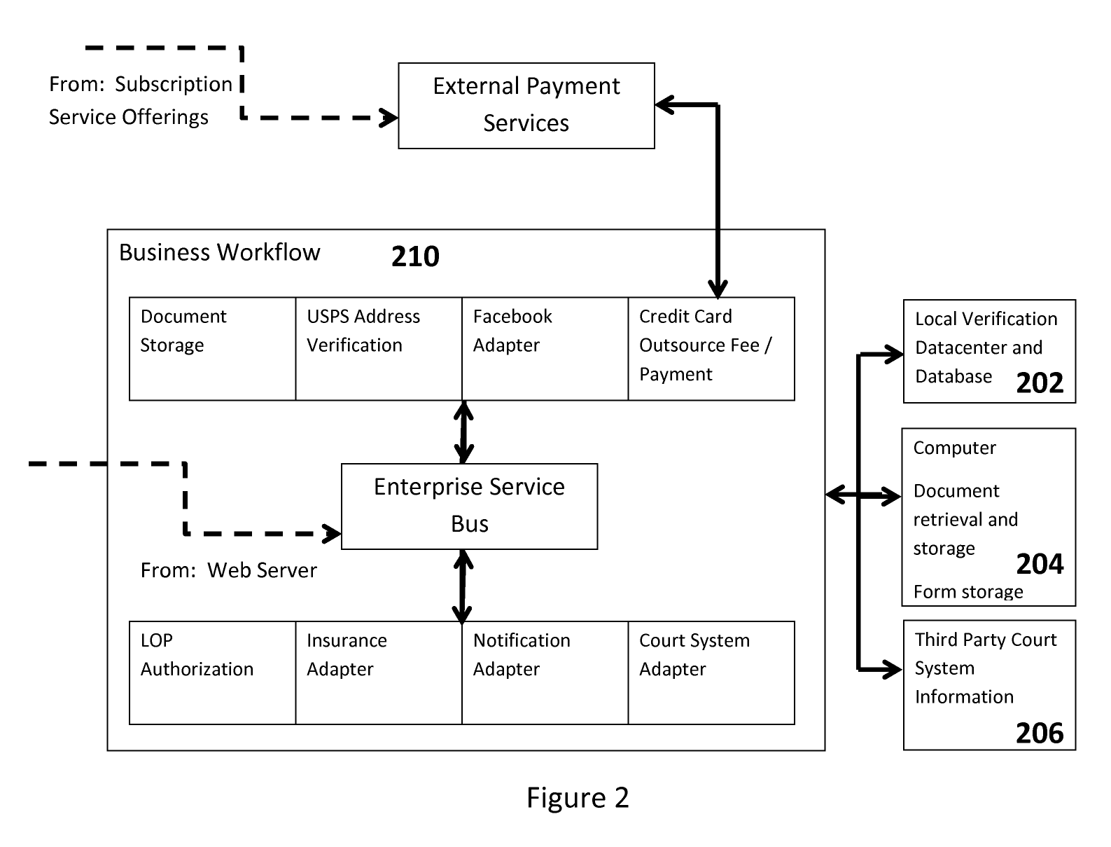

After a client/customer 102 submits his contact information to the subscription service 112, the service 112 may verify the information through various national, state and regional licensing agencies. For example, but not limited to, courts, county record systems, Bar Associations, regional or local licensing boards, third party data aggregators, or other risk management vendors. FIG. 2 shows the retrieval of such information via Verification Database 202, Document Retrieval 204 and Third Party Court System Information 206). Such licensing numbers may be visible to parties searching on the service in order to verify the credentials or current licensing status of a potential LOP partner, for example a doctor 104 or legal representative 106. Upon verification the customer 102 may view the various services that are offered by the subscription service 112.

A doctor 104 may be interested in viewing requests for treatment from a number of patients 110. Alternatively, an attorney 106, on behalf of his client (patient 110), may be interested in viewing the various medical professionals by proximity or the type of medical services that are available through the subscription service. Additionally, the attorney 106 may be interested in only those medical professionals 104 that are willing to accept an LOP.

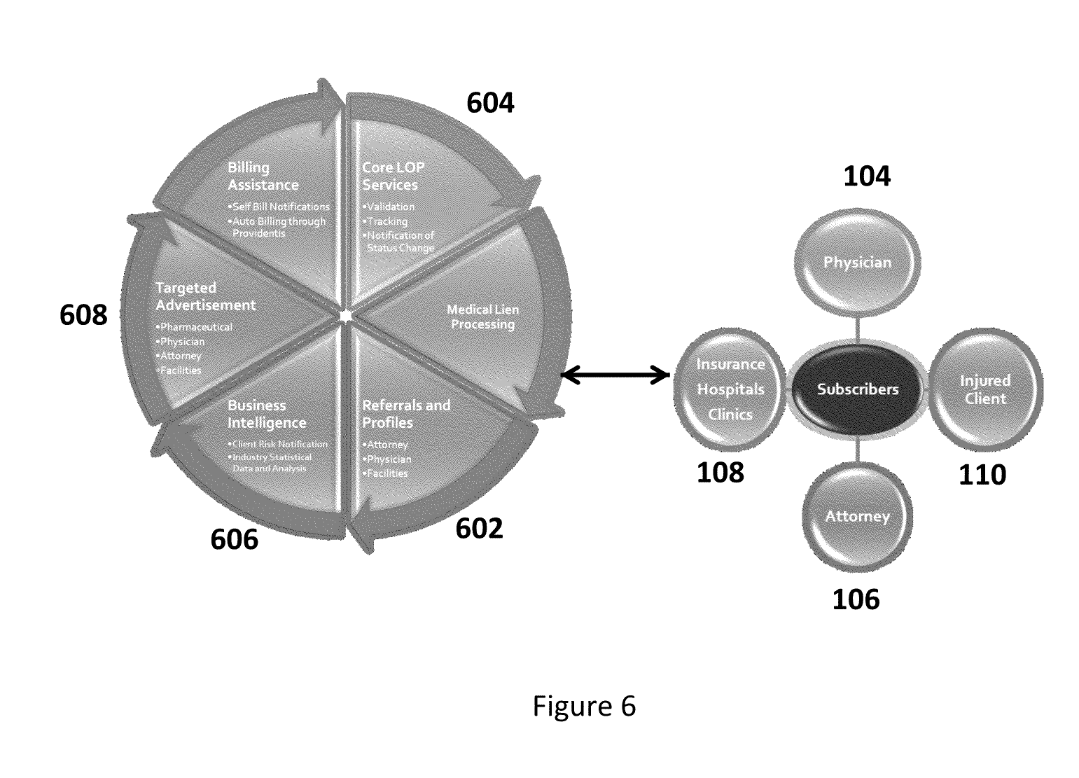

As shown in the FIG. 6, a variety of selections are available to a customer after they have accepted a case. The variety of services available through the service includes, but is not limited to: physician referral option, attorney referral option, matching patient with specialty physician who accepts LOPs, physician profile, attorney profile, (Referrals and Profiles 602); validating LOP, tracking LOP, accounting of activity, notification of status change of LOP (Core LOP Services 604); business intelligence data 606; pharmaceutical banner advertisement , physician banner advertisement, pertinent information and legislation news (Targeted Advertising 608).

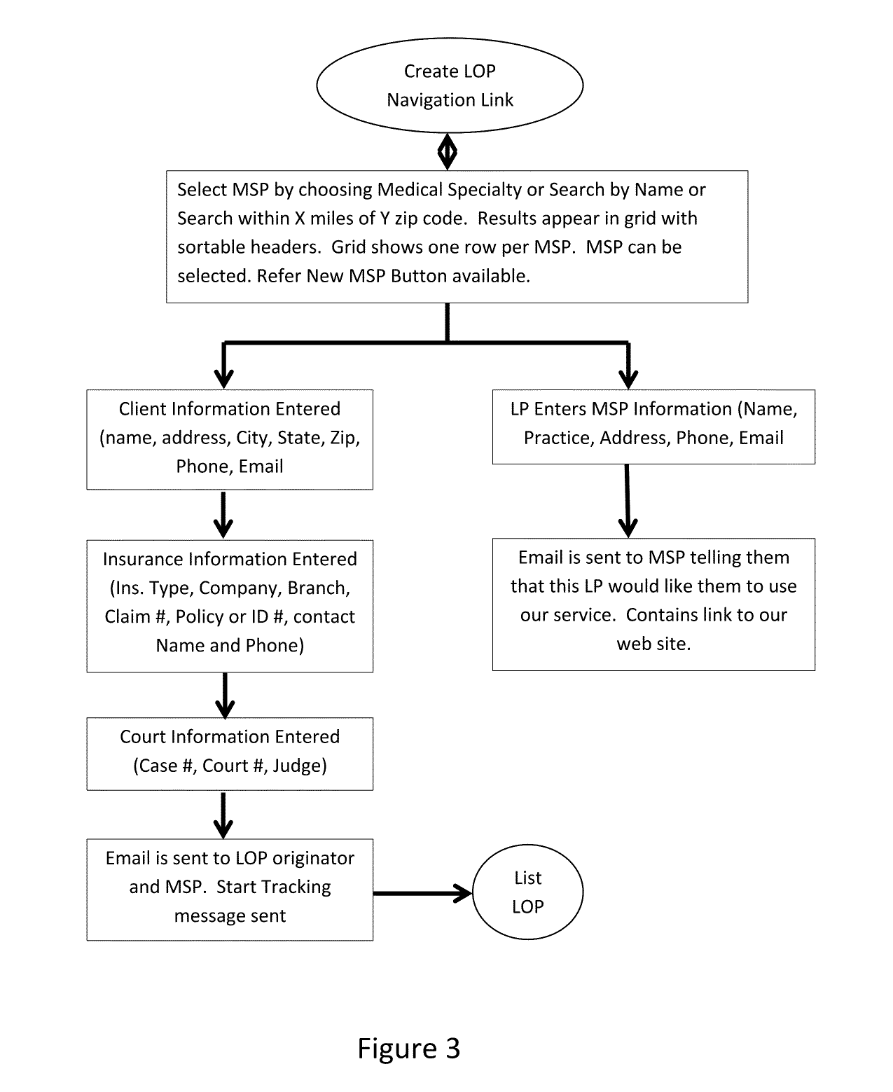

FIG. 3 describes the various information that would be available to an approved client. That information is managed by subscription services offerings 112 and the business workflow 210 of FIGS. 1 and 2. A returning customer may be interested in managing his various cases. A customer may view any updates to the status of current cases or any dates that have been scheduled regarding a specific case, for example the initial filing of a lawsuit or medical appointments made on behalf of the patient. The service may allow medical provider (doctor 104) to enter the patient office visits along with the charges into the system as services are rendered. This creates a real-time billing system for the doctor 104.

It is important for the attorney to be able to access the activity and charges accrued by his client. It is often very difficult to find a medical provider to accept an LOP from an attorney outside their region or one they have not previously worked with. Hence, the present invention may legitimize the participants to some degree, making it more likely to transact business. Alternatively, a subscriber may wish to set notifications at various points during a case. This would generate an automatic notification as various milestones in the case were reached, for example the beginning and ending of a case or a patient missing a medical appointment. This is shown in the management services and notifications block 114 of subscription services 112.

Additionally, the service may provide a way for the other customers to view updates in a case (case management 116). An insurance company 108 may join the service in order to monitor the patient's 110 progress through a series of medical appointments, for example a series of surgeries or physical rehabilitation. The insurance company may require updates to the milestones within a particular case as verification that a patient has attended the scheduled appointments. The service may allow insurance companies to subscribe in order to examine a claimant's history. For example the frequency with which claims are filed, the outcome of past claims, or the number of medical appointments required for a case. A benefit for patient 110 may be the ability to secure a medical provider within convenient proximity.

Thus, the service provides multiple features. The service matches patients (or their legal representative) with needed medical care. The service monitors the progress of a patient through a series of medical appointments. The service satisfies an insurance company's need to know that a patient actually attended the required medical appointments. The service provides automatic verification to customers that the various milestones have been successfully met. Finally, the service provides a timely notification to a physician that a case has been settled, that payment is now possible through the LOP, and may provide an automated billing to the legal representative to make payment on the LOP.

In the preferred embodiment, the subscription service resides on a computer server connected to the internet (business workflow 210). Customers sign on and register with the subscription service through a computer, also attached to the internet; as shown described in FIG. 3. When registering a new customer, various authentications or passwords may be entered by the user or generated by the service computer. The computer maintains a database of the various services that a customer is interested in providing or services that a customer is interested in receiving. Additionally, the service may set permissions or limits on what a customer may see. For example a customer may be allowed to see the date of a patient's past appointments, but not the future appointments or the results of the medical test performed during the appointment.

The service may maintain records of the various milestones of a particular customer. The LOP between the attorney and doctor may be recorded on the subscription service. The start and end date of a trial may be recorded. Also, the dates of various medical appointments and the amounts accumulated and owed. Thus, at the conclusion of a case, a complete report may be viewed or printed out by the various subscribers associated with that case. Finally, automated notification or billing may be sent out to the appropriate subscribers. Subscribers or customers 102 may include attorneys 106, attorney clients (patients 110), medical professionals 104, insurance companies 108 and others that are allowed to join the subscription service.

The service may monitor various dates associated with the case through a court case number or insurance case or claim number. Such a number may be entered by one of the customers associated with the case in order to allow monitoring of the court dates and/or settlement dates of a case. Third party systems currently exist that aggregate insurance, claim, and financial data. These systems may provide risk management services to subscribers during the pendency of the case or claim. The service may also monitor other record systems such as county records, court house records, or newspaper classifieds for information relating to the case (represented by 202, 204 and 206 of FIG. 2). By monitoring such systems through a court case or insurance case or claim number, the service can automatically import important milestones related to the case, such as the beginning of a lawsuit or the finalization of a case or claim. Also, the service may supply automatic notifications and billing through email or by other information, such as a mailing address, supplied by customers. A case or claim may include an insurance claim filed on personal insurance, an accident claim filed against another's insurance, a lawsuit, arbitration, or a similar action between two or more parties.

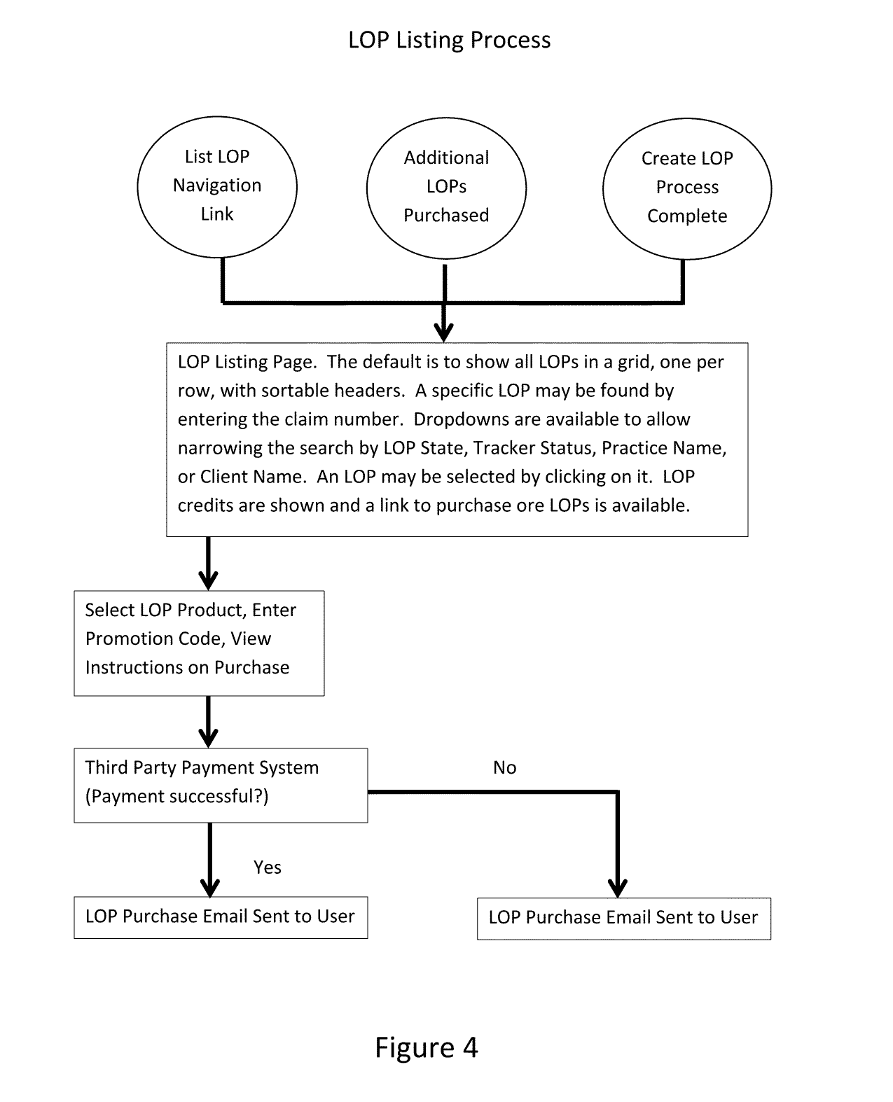

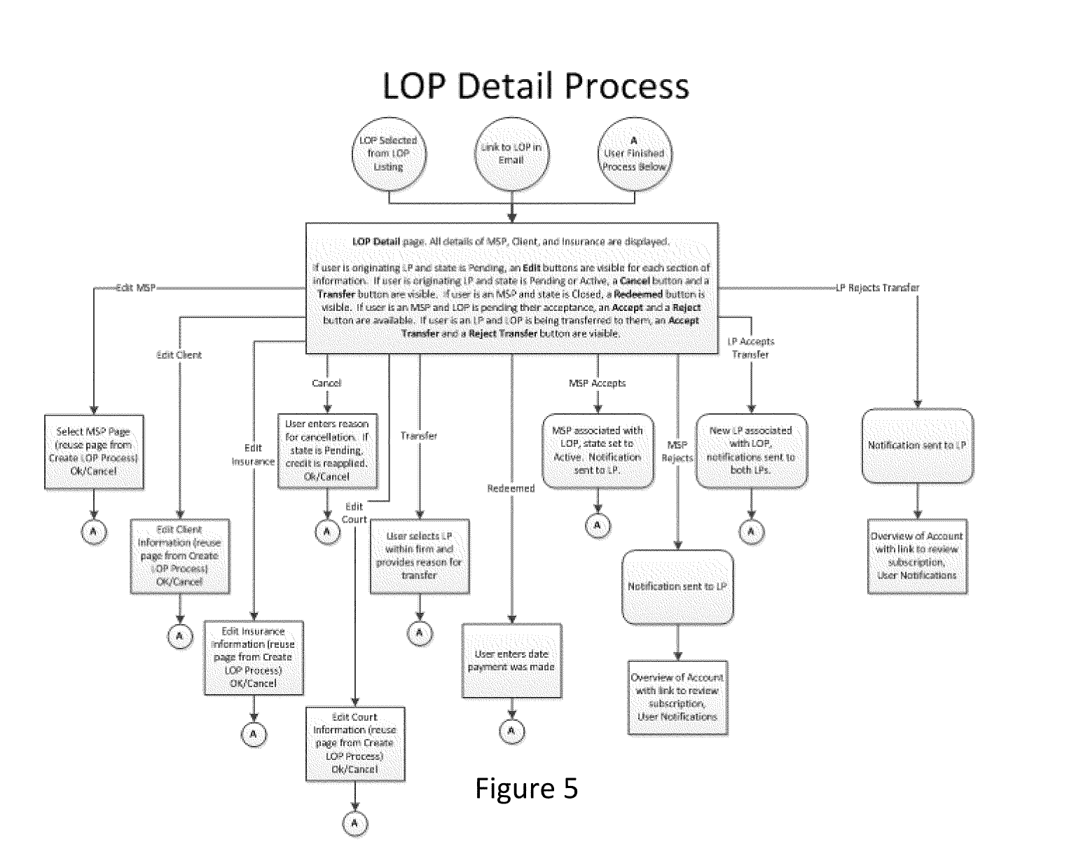

The subscription service offers the additional benefit of having a transferrable system of records. Case related records may be transferred to a member's local drive as a back-up copy or for viewing when the local computer system does not have an internet connection. Additionally, records may be transferrable to other software such as billing or tax programs, saving members time and expense of manual entry. Also, a member may wish to transfer past cases to the subscription service to allow for a complete viewing of their records while examining files on the subscription service. The transfer of files based on file type and the required modifications of files for transfer are well known in the art. Finally, the system would allow for the transfer of an LOP between members (as shown in FIG. 4). For example, a law firm that is closing may wish to transfer the LOP to another firm or a member may be required to transfer the LOP to an insurance provider upon receipt of payment.

Another benefit of the subscription service is the referral of colleagues (602 of FIG. 6). The subscription service provides a referral mechanism, wherein a user may notify a colleague of the system via email. The system may include a link to a web address where the subscription service resides. The entry web page may include information describing the service, as well as potential discounts for entering as a referral. Additionally, the referring member may be eligible for discounts or other offers based on the referral.

Case research may include validation of claim and its parties including attorney, patient, responsible insurance company, and physicians. This would allow the various customers to research the other parties in a case. The research may include investigation of credentials and past cases (604 of FIG. 6).

Conversion and Keyed Services: the service may allow subscribers to load existing/archived LOP's into the systems (contract services 118 of FIG. 1). This is a reverse method for the system to notify an attorney 106 that a medical professional 104, with whom they have an LOP, has requested the service track and report the status of the LOP. At the request of subscribers, a team of trained contractors may be supplied by the service to assist in inputting existing LOPs into the service for tracking.

Alternately, LOPs that have been created manually outside this service may be entered by a subscriber to allow tracking of previous LOPs. This will allow the system to automatically track LOPs created outside of the system.

A comprehensive marketing and networking campaign may be offered through they system (targeted advertisement 608 of FIG. 6). Ads may be targeted directly towards subscribers (clients 102) based on personal information. The personal information may be entered into the system by a subscriber 102 or added to the system through a search of a third party data aggregator. The advertisements may integrate social media websites. Such websites may also be used by the service for communication, referral and collaboration between subscribers 102.

The service will allow the subscribers 102 to rate and/or rank the medical service providers (MSPs) and Legal Providers (LPs) with whom they have dealt. This feature will be a tool by which future business transactions will be influenced. For example, MSPs may rate doing business with an attorney based on factors such as ease of transacting business; average length of time it takes attorney to settle a case; average length of time it takes attorney to reimburse MSP for treatment rendered to patient.

As shown on the left of FIG. 6, the various subscribers 102, may interact between one another. For example, subscribers 102 may refer their clients to other subscribers. In addition, the client 110 can rate the service offered by either party handling their treatment and case. Referrals may include an offer of insurance that relates to the various subscribers, their specialties, or circumstances surrounding the case.

The system will enable both attorney 106 and medical provider 104 to recommend the system to colleagues, which will grow subscribers 102, ultimately increasing value and service options to injured patients.

The service may allow the LOP to be transferred to another firm should the attorney move to another law firm. Customers may cancel their subscription at any point and choose to have their data removed from the system. The service may allow subscribers to view aggregated data from the system. This may be of special interest to insurance companies as it could be used as reference data based on the nature of case, geographical location, or the number of appointments required for a specific type of injury, among other things.

Payment for services may be made on the system through various banking systems including direct deposit, bank card, ACH bank drafts, PayPal, ClickBank, or other methods.

1. A method of creating an LOP between a patient and a service provider, the patient supplying patient data and a request for service, the service provider supplying service information, the method comprising:
comparing the request for service to the service information;
sending a notification of an opportunity to the service provider;
sending an offer of services to the patient on behalf of the service provider;
receiving acceptance of the offer of services from the patient; and
generating an LOP based on the offer of services.

2. The method of claim 1 further comprising:
Sending the notification of the opportunity to multiple service providers based on the request for service.

3. The method of claim 2 further comprising:
limiting the field of service providers notified of the opportunity based on geographical information.
